(19) United States
(12) Patent Application Publication
(10) Pub. No.: US 2006/0227004 A1
(43) Pub. Date: Oct. 12, 2006

(54) Apparatus and method for networked remote control

(75) Inventors: Yuen Khim Liow, Singapore (SG); Siang Thia Goh, Singapore (SG); Angela Jean, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/101,738

(22) Filed: Apr. 8, 2005

(51) Int. Cl. H04Q 1/00

(52) U.S. Cl. 340/825.69; 340/310.11

(57) ABSTRACT

Apparatus is disclosed for enabling remote control of an appliance by use of a network. The apparatus comprises a wireless receiver and transmitter for receiving a remote control command signal from a remote control unit in a non-network format; and a processor for encoding the remote control command into a network protocol and sending the encoded remote control command over the network to the appliance. The remote control unit is an infrared remote control unit, and the wireless receiver and transmitter is an infrared receiver and transmitter. The apparatus is integral with a fitting for an electrical appliance and the network is an electrical supply network.

### FIELD OF THE INVENTION

This invention relates to an apparatus and method for networked remote control and refers particularly, though not exclusively, to such an apparatus and method using the network for remote control of an appliance.

### BACKGROUND TO THE INVENTION

Wireless connectivity of computers with domestic appliances to allow the computer to be used to control the appliances has been promoted but has achieved limited success. Part of the problem is that wireless connectivity works well in an open plan environments but doesn't work as well when there are intervening wall and floors. This is particularly so when the intervening wall or floor is made of a material such as, for example, reinforced concrete.

When using remote control devices, particularly infrared remote control devices, there must be a clear line of sight between the remote control device and the apparatus being controlled. Infrared repeaters are available, but these require significant numbers and lengths of cables to be effective.

One appliance for which an infrared remote control is often used is an entertainment system such as, for example, a home theatre system, stereo system, or the like. For example, if the entertainment system is being used to play music that can be heard in a number of rooms, the user must be in the room where the entertainment system is located to be able to change the volume, track, disk, or the like. Other than long cables or wirelessly, there is no known way of having remote speakers for an entertainment system being able to be controlled no matter where in the house the user may be.

Power line networking has been proposed for some time and, to a limited extent, has been used for a few years. The “Home Plug” standard has attempted to provide a uniform standard in a domestic environment and to promote its adoption.

### SUMMARY OF THE INVENTION

In accordance with a first preferred aspect there is provided apparatus for enabling remote control of an appliance by use of a network. The apparatus comprises a wireless receiver and transmitter for receiving a remote control command signal from a remote control unit in a non-network format. A processor is provided for encoding the remote control command into a network protocol and sending the encoded remote control command over the network to the appliance.

According to a second aspect there is provided apparatus for reproduction of a data stream sent to the apparatus by an appliance by use of a network. The apparatus comprises a processor for receiving and decoding the data stream into a reproducible format and sending the decoded data stream to an output. The output is for enabling the reproduction of the reproducible format of the data stream. The data stream and the appliance are able to be remotely controlled by a remote control.

According to a third aspect there is provided a method of remotely controlling an appliance over a network by use of an apparatus. The method comprises sending a remote control signal to a receiver and transmitter of the apparatus. The receiver and transmitter sends the remote control signal to a processor of the apparatus. The remote control signal is encoded into a network format in a processor and is sent to the appliance over the network

For all aspects the remote control unit may be an infrared remote control unit, and the wireless receiver and transmitter may be an infrared receiver and transmitter. The apparatus may be integral with a fitting for an electrical appliance, and the network may be an electrical supply network. Alternatively, the apparatus may be integral with a fitting for an electrical lamp. Preferably, the remote control signal is not network compatible. Alternatively, the network is a wireless network.

The apparatus may further comprise a network controller, the network protocol preferably being a TCP/IP controller. The apparatus may further comprise a network adapter.

The appliance may comprise a transmitting unit, the transmitting unit comprising a second receiver and transmitter, and a second processor, for receiving and decoding the remote control command signal to enable the remote control command signal to be effective at the appliance.

The apparatus may further comprise an output for receiving decoded data from the processor, the processor also being for receiving and decoding encoded data from the appliance, the encoded data being able to be sent to the processor over the network.

The apparatus may further comprise a microphone for receiving audio input, the processor also being for encoding and sending the received audio; and a digital camera for receiving a video input, the processor also being for encoding and sending the video input.

### BRIEF DESCRIPTION OF THE DRAWINGS

In order that the invention may be fully understood and readily put into practical effect, there shall now be described by way of non limitative example, only preferred embodiments of the present invention, the description being with reference to the accompanying illustrative drawings.

In the drawings:

FIG. 1 is a schematic view of a first embodiment in a domestic situation;

FIG. 2 is a block diagram of the embodiment of FIG. 1;

FIG. 3 is a flow chart of the embodiment of FIGS. 1 and 2;

FIG. 4 is an illustration of a preferred embodiment of an apparatus; and

FIG. 5 is a block diagram of the apparatus of FIG. 4.

### DETAILED DESCRIPTION OF PREFERRED EMBODIMENT

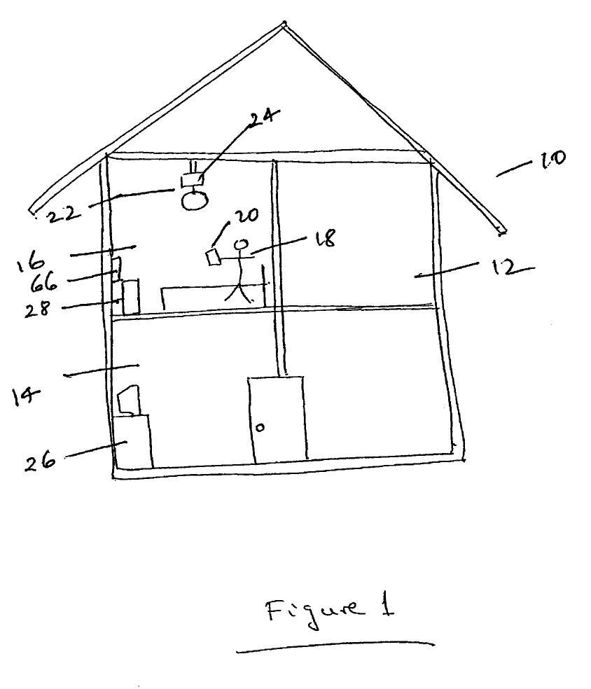

To refer to FIG. 1, there is shown a home 10 having several rooms 12. In a first room 14 is located an entertainment system 26 that is operatively connected to the electricity supply of the home 10 for both the supply of electrical power to the entertainment system 26, and for the sending of signals by and the receiving of control signals for the entertainment system 26 by use of, for example, TCT/IP. However, other network protocols may be used.

In a second room 16 is located a user 18 who is able to use an infrared remote control 20 to control the audio reproduced by remote speakers 28 operatively connected to the entertainment system 26. This is by use of apparatus 24 that is a receiving unit forming part of a lamp assembly 22.

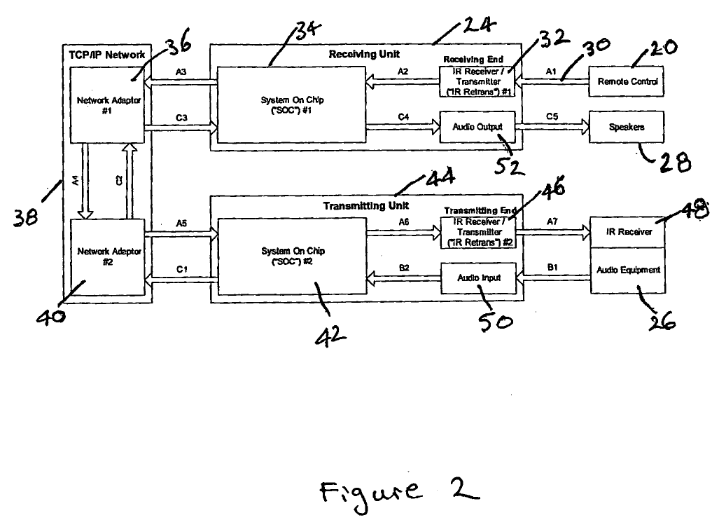

In FIG. 2 the infrared remote control 20 is able to send a signal 30 to the apparatus 24 as there a clear line of sight. The signal 30 may be any suitable signal from the remote control 20 such as, for example, to change the volume of the speakers 28, to switch off the entertainment system 26, to change a track, and so forth. The apparatus 24 includes an infrared receiver/transmitter 32 that receives the signal 30 and sends it to a processor 34 such as, for example, a system-on-a-chip, for the signal 30 to be encoded into a data packet. The encoded data packet is sent by processor 34 to a network adapter 36 that forms part of a TCP/IP network 38. The network is preferably the electricity power supply network for house 10, although other networks such as, for example, wireless networks may be used in addition or alternatively. The network adapter 36, in turn, sends the encoded data packet over network 38 to a second network adapter 40 also forming part of the network 38.

The second network adapter 40 sends the encoded data packet to a second processor 42 that is part of a transmitting unit 44 operatively connected to, or forming part of, the entertainment system 26. The second processor 42 may also be a system-on-a-chip. The second processor 42 decodes the data packet and sends the signal 30 to an infrared receiver and transmitter 46 that, in turn, sends the signal 30 to an infrared receiver 48 built in to or operatively connected to entertainment system 26. The signal 30 is then acted on by the entertainment system 26.

The same system may be used for sending audio from the entertainment system 26 to the remote speakers 28. To do this the audio is send from the entertainment system 26 to the transmitting unit 44 where it is received by an audio input 50 that, in turn, sends the audio to the second processor 42 for encoding. The encoded audio is sent to the second network adapter 40 and then to the network adapter 36 over network 38. Network adapter 36 received the encoded audio and sends it to the processor 34 forming part of the receiving unit 24. The audio is decoded and passed to an audio output 52. The audio is then sent to the speakers 28 for reproduction. The audio may be sent to the speakers 28 directly over the network 38 and be controlled by use of remote control 20 and the receiving unit 24, or may be sent to the speakers 28 by the receiving unit 24. Network adapters 36, 40 may be part of the receiving unit 24 and the transmitting unit 44, if required or desired.

The processors 34, 42 both include coders/decoders to enable this to be done. The audio may be sent over the network 38 using any known audio streaming or broadcast protocol. The infrared receiver/transmitter 32 may be an integral unit, or the transmission function and the receiving function, may be separated into different units.

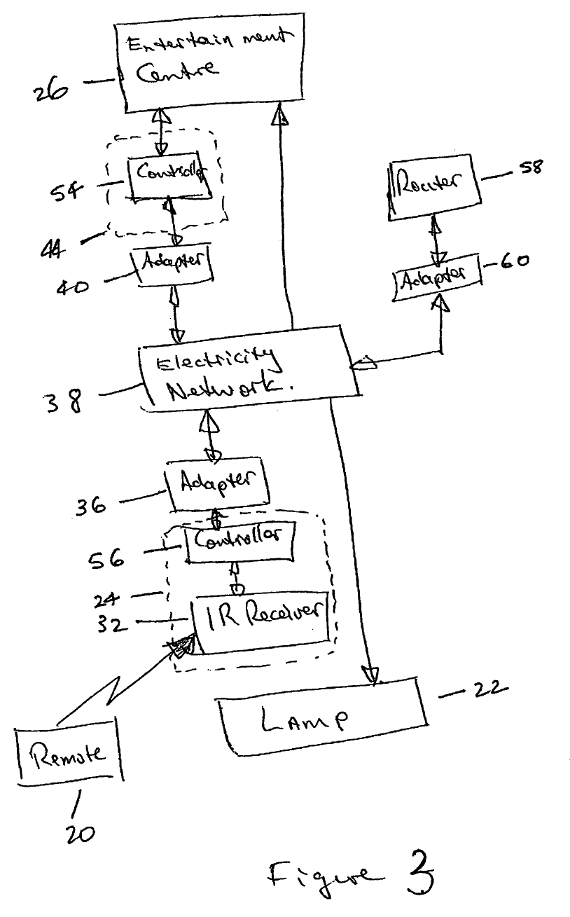

This is further illustrated in FIG. 3 where the network 38 is the electricity supply network for the house 10. As can be seen the entertainment system 26 communicates with the electricity network 38 using a TCP/IP controller 54 and the network adapter 40, and the infrared receiver/transmitter 32 communicates with the electricity network 38 using the adapter 36 as well as a TCP/IP controller 56. To control communication over the electricity network 38 a router 58 and network adapter 60 are used.

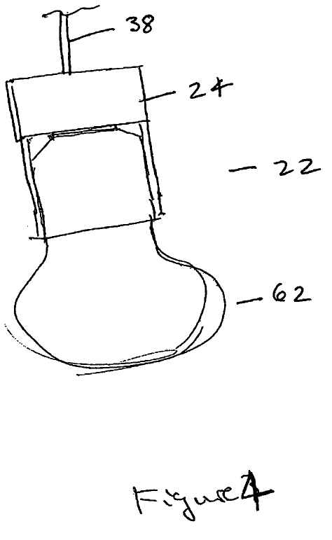

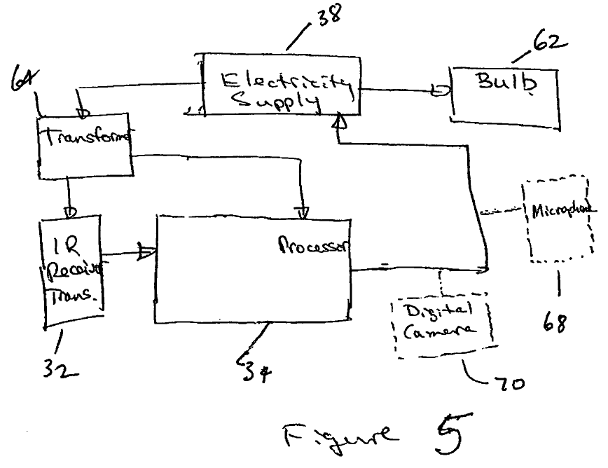

FIGS. 4 and 5 show how the receiving unit 24 may be incorporated into the lamp assembly 22. The electricity network 38 is connected to the lamp assembly 22 to supply electrical power to a globe or bulb 62 releasably insertable into the assembly 22 by any suitable and known means. For example, it may be by use of a bayonet fitting, an Edison fitting, and so forth. A transformer 64 is provided to reduce the voltage to a suitable level for use by the infrared receiver/transmitter 32 and the processor 34. Although a ceiling-mounted lamp is shown any form of table, reading, standard or other lamp may be used; as may be any other form of electrical appliance where there will be a clear line of sight from the remote control 20 to infrared receiver transmitter 32. The infrared receiver 48 may be the infrared receiver that is normally built into entertainment systems.

Although a lamp assembly is shown, it may be, for example, a plug at the end of a lead, or otherwise. It may be built in to an electrical appliance.

Naturally, the electricity supply 38 must be maintained for the supply of the audio, and for the ability to respond to remote control commands, to be able to continue. Therefore, any switch 66 for controlling the lamp assembly 22 may be fitted with an infrared receiver, or other wireless receiver, so that the processor 34 can send an instruction to the switch 66 so that it can not be switched to OFF when the receiving unit 24 is in operation. A back-up battery may be provided in receiving unit 24 so that if the remote control 20 is operated when the electricity supply to the receiving unit 24 is not on—i.e. switch 66 is off—the back up battery with be able to provide enough power for the processor 34 and the receiver/transmitter 32 to send a signal to switch 66 to move to the on position so as to restore power to the receiving unit 24.

The receiving unit 24 may also include a microphone 68 to enable voice-activated commands to be used in place of or in addition to the remote control 20. In such a case the processor 34 would include a voice recognition capability. Furthermore, or alternatively, a digital camera 70 may be provided so that motion sensing capabilities may be included in processor. In this way the receiving unit 24 may be able to detect a lack of motion and thus switch off the speakers 28 and/or lamp 62. This will prevent unnecessary electrical power wastage. Microphone 68 and/or camera 70 may also be able to be used for monitoring and/or security purposes. For example, if the occupant of the room 16 was a baby, parents in room 14 could use the microphone 68 and/or camera 70 to monitor the baby, rather than a separate installation, as is often used at present.

Although the remote control 20 is not a TCP/IP unit, nor is it TCP/IP compatible, it can be used for controlling the transmission of signals over a TCP/IP network by use of the receiving unit 24 even though the remote control unit signals are in a non-network format and are not network compatible. Also, although audio is described, any other form of media may be sent over the network 38 including video, audio, multimedia, and so forth; as may be any other form of data or data stream.

In addition or alternatively, the network 30 may comprise any other form of network such as, for example, a wireless network including Bluetooth and WiFi networks.

Whilst there has been described in the foregoing description preferred embodiments of the present invention, it will be understood by those skilled in the technology concerned that many variations or modifications in details of design, construction or operation may be made without departing from the present invention as defined in the following claims.

1. Apparatus for enabling remote control of an appliance by use of a network, the apparatus comprising:
(a) a wireless receiver and transmitter for receiving a remote control command signal from a remote control unit in a non-network format;
(b) a processor for encoding the remote control command into a network protocol and sending the encoded remote control command over the network to the appliance.

2. Apparatus as claimed in claim 1, wherein the remote control unit is an infrared remote control unit with the remote control command signal not being network compatible, and the wireless receiver and transmitter is an infrared receiver and transmitter.

3. Apparatus as claimed in claim 1, where the apparatus is integral with a fitting for an electrical appliance, the network being an electrical supply network.

4. Apparatus as claimed in claim 2, wherein the apparatus is integral with a fitting for an electrical lamp, the network being an electrical supply network.

5. Apparatus as claimed in claim 3 further comprising a network controller.

6. Apparatus as claimed in claim 1, wherein the network protocol is TCP/IP.

7. Apparatus as claimed in claim 1 further comprising a network adapter.

8. Apparatus as claimed in claim 1, wherein the appliance comprises a transmitting unit, the transmitting unit comprising a second receiver and transmitter, and a second processor, for receiving and decoding the remote control command signal to enable the remote control command signal to be effective at the appliance.

9. Apparatus as claimed in claim 1 further comprising an output for receiving decoded data from the processor, the processor also being for receiving and decoding encoded data from the appliance, the encoded data being able to be sent to the processor over the network.

10. Apparatus as claimed in claim 1 further comprising a microphone for receiving audio input, the processor also being for encoding and sending the received audio.

11. Apparatus as claimed in claim 1 further comprising a digital camera for receiving a video input, the processor also being form encoding and sending the video input.

12. Apparatus for reproduction of a data stream sent to the apparatus by an appliance by use of a network, the apparatus comprising:
(a) a processor for receiving and decoding the data stream into a reproducible format and sending the decoded data stream to an output
(b) the output being for enabling the reproduction of the reproducible format of the data stream;
(c) the data stream and the appliance being able to be remotely controlled by a remote control.

13. Apparatus as claimed in claim 12, where the apparatus is integral with a fitting for an electrical appliance, the network being an electrical supply network.

14. Apparatus as claimed in claim 13, wherein the apparatus is integral with a fitting for an electrical lamp, the network being an electrical supply network.

15. Apparatus as claimed in claim 14 further comprising a network controller.

16. Apparatus as claimed in claim 12, wherein the network protocol is TCP/IP.

17. Apparatus as claimed in claim 12 further comprising a network adapter.

18. Apparatus as claimed in claim 12, wherein the appliance comprises a transmitting unit, the transmitting unit comprising a second receiver and transmitter, and a second processor, for receiving and decoding the remote control command signal to enable the remote control command signal to be effective at the appliance.

19. Apparatus as claimed in claim 1, wherein the network is a wireless network.

20. A method of remotely controlling an appliance over a network by use of an apparatus, the method comprising:
(a) sending a remote control signal to a receiver and transmitter of the apparatus, the remote control signal being in a non-network format;
(b) the receiver and transmitter sending the remote control signal to a processor of the apparatus;
(c) encoding the remote control signal into a network format in a processor; and
(d) sending the encoded remote control signal to the appliance over the network.

21. A method as claimed in claim 20, where the apparatus is integral with a fitting for an electrical appliance, the network being an electrical supply network.

22. A method as claimed in claim 20, wherein the network protocol is TCP/IP.

23. A method as claimed in claim 21 further comprising using a network adapter to adapt the encoded remote control signal for transmission over the network.

24. A method as claimed in claim 20, wherein the encoded remote control signal is received and decoded and sent to the appliance to enable the remote control signal to be effective at the appliance.

25. A method as claimed in claim 24, wherein a data stream is encoded and send over the network to the processor, the received encoded data stream is decoded, and the decoded data stream is sent for reproduction under the control of the remote control.

26. A method as claimed in claim 20, wherein the remote control signal is not network compatible.

27. A method as claimed in claim 20, wherein the network is a wireless network.
